(19) United States
(12) Patent Application Publication
(10) Pub. No.: US 2019/0088425 A1
(43) Pub. Date: Mar. 21, 2019

(54) KEYBOARD AND MEMBRANE SWITCH CIRCUIT

(71) Applicant: Primax Electronics Ltd., Taipei (TW)

(72) Inventor: Lei-Lung TSAI, Taipei (TW)

(21) Appl. No.: 15/835,950

(22) Filed: Dec. 8, 2017

(30) Foreign Application Priority Data
Sep. 15, 2017 (TW) 106131803

(51) Int. Cl. H01H 13/02; H01H 13/83; H01H 13/705

(52) U.S. Cl. CPC H01H 13/023; H01H 2219/036; H01H 13/705; H01H 13/83

(57) ABSTRACT

The present invention relates to a keyboard, including a membrane switch circuit and a light emitting element capable of generating a light beam. The membrane switch circuit includes a board body and a circuit structure, and the circuit structure includes a conductive circuit and a protection layer. The conductive circuit is disposed in the board body and electrically connected to the light emitting element. The conductive circuit includes a first-section circuit and a second-section circuit. A gap is provided between the first-section circuit and the second-section circuit. The first-section circuit and the second-section circuit are wrapped by the protection layer to increase a resistance value of the circuit structure, so as to reduce brightness of the light beam.

### FIELD OF THE INVENTION

The present invention relates to a keyboard, and in particular, to a keyboard having an indicator light.

### BACKGROUND OF THE INVENTION

Common computer peripheral input devices include a mouse, a keyboard, a track ball, and the like. The keyboard can directly input texts and symbols to a computer and therefore is highly appreciated by users and input device vendors.

Refer to FIG. 1, which is a schematic structural diagram of the appearance of a conventional keyboard. A conventional keyboard 1 is connected to a computer (not shown in the figure) and the surface of the conventional keyboard 1 is provided with a plurality of keys 10 and light emitting elements 11. The keys 10 are classified as ordinary keys 101, number keys 102, function keys 103, and so on. When pressed by fingers of a user, these keys generate corresponding signals which are sent to the computer, so that the computer executes functions of the pressed keys. For example, the ordinary keys 101 are used for inputting English letters and other symbols, the number keys 102 are used for inputting numbers, and the function keys 103 are used for providing various functions, such as F1 to F12. The light emitting element 11 may generate a light beam and project the light beam to outside of the keyboard 1, so as to produce a light emitting effect.

Next, refer to FIG. 2, which is a schematic diagram of a partial structure of a membrane switch circuit of a conventional keyboard. FIG. 2 shows a partial structure of a membrane switch circuit 12 of the conventional keyboard 1 and a light emitting element 112. The membrane switch circuit 12 includes a board body 121, a plurality of conductive circuits 122 and a plurality of contact portions 123 (i.e., the so-called golden fingers). The plurality of conductive circuits 122 is disposed in the board body 121 by means of printing and is electrically connected to the light emitting element 11. Each contact portion 123 corresponds to one conductive circuit 122, and is electrically connected to the corresponding conductive circuit 122. The plurality of contact portions 123 is exposed out of the board body 121 and may be connected to an external power supply to obtain power, thereby driving the membrane switch circuit 12 and the light emitting element 11.

Recently, users think that the light beam of the light emitting element 11 is excessively bright and require a decrease in the brightness of the light beam. Generally, the brightness of the light beam of the light emitting element 11 is reduced by increasing a resistance value of the conductive circuit 122 connected to the light emitting element 11. According to the resistance formula, the resistance value of the conductive circuit 122 can be increased by increasing the length of the conductive circuit 122. However, the resistance value can only be increased by a limited degree in such a manner, and therefore the brightness of the light beam of the light emitting element 11 is not significantly reduced.

Therefore, a keyboard that can reduce the brightness of the light beam of the light emitting element is needed.

### SUMMARY OF THE INVENTION

An objective of the present invention is to provide a keyboard that can reduce brightness of a light beam of a light emitting element.

Another objective of the present invention is to provide a membrane switch circuit that can reduce brightness of a light beam of a light emitting element.

In a preferred embodiment, the present invention provides a membrane switch circuit, which is connected to a light emitting element capable of generating a light beam. The membrane switch circuit includes a board body and a circuit structure. The circuit structure is disposed in the board body and connected to the light emitting element. The circuit structure includes a conductive circuit and a protection layer. The conductive circuit is disposed in the board body and electrically connected to the light emitting element. The protection layer wraps the conductive circuit inside the board body and is used for protecting the conductive circuit. The conductive circuit includes a first-section circuit and a second-section circuit. A gap is provided between the first-section circuit and the second-section circuit. The first-section circuit and the second-section circuit are wrapped by the protection layer to increase a resistance value of the circuit structure, so as to reduce brightness of the light beam.

In a preferred embodiment, the present invention provides a keyboard, including a light emitting element and a membrane switch circuit. The light emitting element is disposed in the keyboard and is used for generating a light beam. The membrane switch circuit is disposed in the keyboard and connected to the light emitting element. The membrane switch circuit includes a board body and a circuit structure. The circuit structure is disposed in the board body and connected to the light emitting element. The circuit structure includes a conductive circuit and a protection layer. The conductive circuit is disposed in the board body and electrically connected to the light emitting element. The protection layer wraps the conductive circuit inside the board body and is used for protecting the conductive circuit. The conductive circuit includes a first-section circuit and a second-section circuit. A gap is provided between the first-section circuit and the second-section circuit. The first-section circuit and the second-section circuit are wrapped by the protection layer to increase a resistance value of the circuit structure, so as to reduce brightness of the light beam.

In a preferred embodiment, the resistance value of the circuit structure is a sum of a resistance value of the first-section circuit, a resistance value of the second-section circuit, and a resistance value of the protection layer located between the first-section circuit and the second-section circuit.

In brief, in the keyboard and membrane switch circuit according to the present invention, the conductive circuit in the board body is divided into the first-section circuit and the second-section circuit separate from each other, and the first-section circuit and second-section circuit are wrapped by the protection layer, thereby forming a series architecture of the first-section circuit, the protection layer located between the first-section circuit and the second-section circuit, and the second-section circuit. Therefore, the resistance value of the circuit structure can be increased to a sum of the resistance value of the first-section circuit, the resistance value of the second-section circuit, and the resistance value of the protection layer located between the first-section circuit and the second-section circuit, so that the brightness of the light beam generated by the light emitting element can be reduced.

### BRIEF DESCRIPTION OF THE DRAWINGS

FIG. 1 is a schematic structural diagram of the appearance of a conventional keyboard;

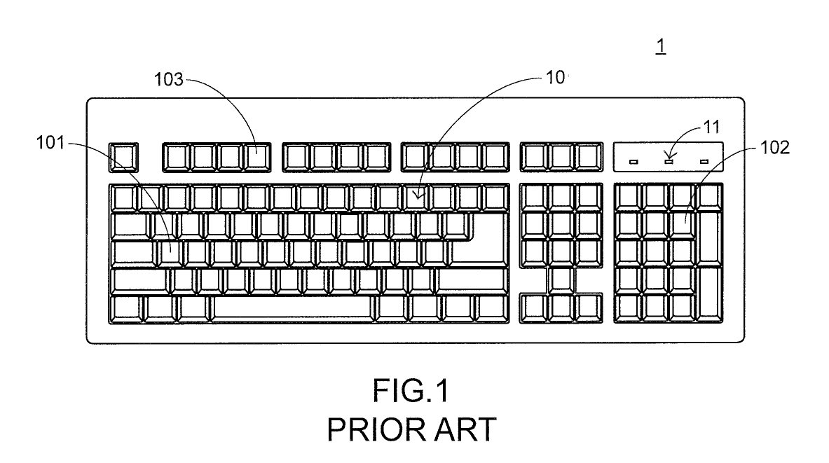

FIG. 2 is a partial schematic structural diagram of a membrane switch circuit of a conventional keyboard;

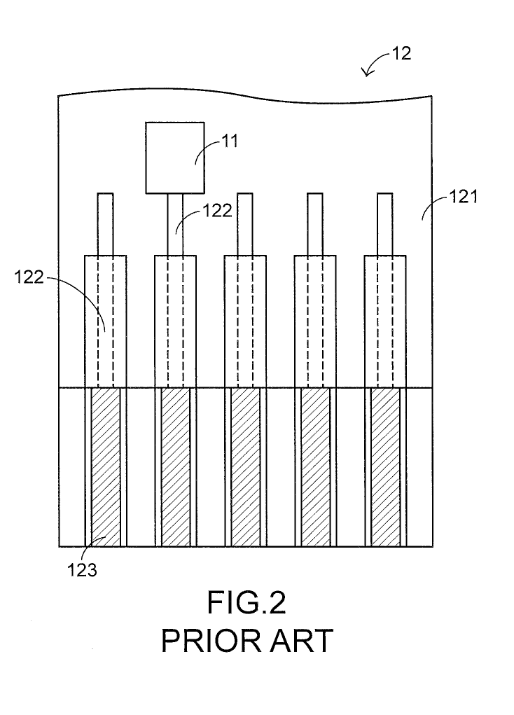

FIG. 3 is a schematic structural diagram of a keyboard according to a preferred embodiment of the present invention;

FIG. 4 is an exploded schematic diagram of a partial structure of a keyboard according to a preferred embodiment of the present invention; and

FIG. 5 is an exploded schematic diagram of a partial structure of a membrane switch circuit of a keyboard according to a preferred embodiment of the present invention.

### DETAILED DESCRIPTION OF THE PREFERRED EMBODIMENT

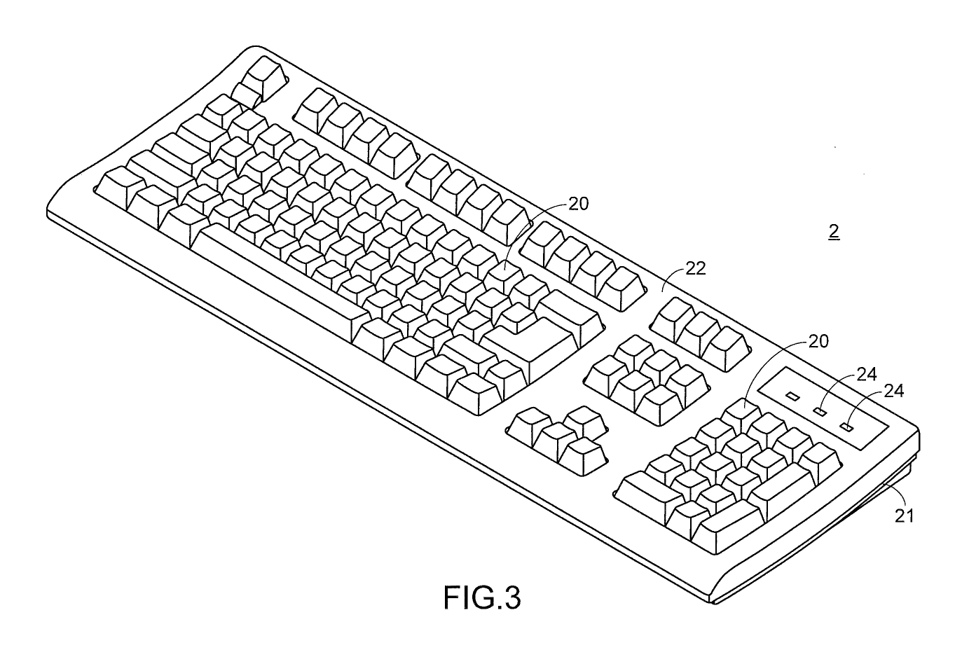

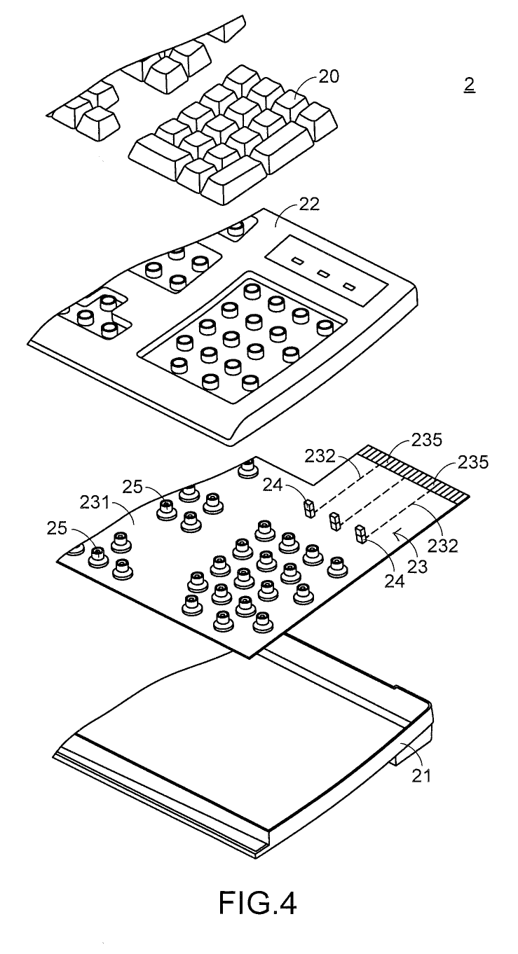

In view of the trouble caused by the conventional technology, the present invention provides a keyboard and a membrane switch circuit that can solve the problem in the conventional technology. First of all, the structure of the keyboard in the present invention is described. Refer to FIG. 3 and FIG. 4 together. FIG. 3 is a schematic structural diagram of a keyboard according to a preferred embodiment of the present invention and FIG. 4 is an exploded schematic diagram of a partial structure of a keyboard according to a preferred embodiment of the present invention. A keyboard 2 of the present invention includes a plurality of keycaps 20, a base 21, an upper cover 22, a membrane switch circuit 23, a plurality of light emitting elements 24 and a plurality of elastic elements 25. The plurality of keycaps 20 and the plurality of light emitting elements 24 are exposed out of the upper cover 22 of the keyboard 2. The plurality of keycaps 20 can be pressed by a user, so as to trigger the plurality of elastic elements 25 and the membrane switch circuit 23. The base 21 can carry the plurality of keycaps 20, the membrane switch circuit 23 and the plurality of elastic elements 25 thereon. The upper cover 22 covers the base 21, so that the membrane switch circuit 23, the plurality of light emitting elements 24 and the plurality of elastic elements 25 are located between the base 21 and the upper cover 22.

The membrane switch circuit 23 is disposed on the base 21 and electrically connected to the plurality of light emitting elements 24. The plurality of elastic elements 25 is disposed on the membrane switch circuit 23 and in contact with the plurality of keycaps 20. When the user presses the keycap 20, the keycap 20 moves downward and presses the corresponding elastic element 25, so that the elastic element 25 presses the membrane switch circuit 23. Then, the membrane switch circuit 23 can generate a corresponding key signal. In this preferred embodiment, the elastic element 25 is an elastic rubber body, and the keyboard 2 employs a volcano-shaped connection structure used for a desktop computer. This is merely an example, and the present invention is not limited thereto. In another preferred embodiment, the plurality of keycaps may also be actuated by using a scissors-type connection element. In addition, a magnetic manner may be employed to control the keycaps to move up and down.

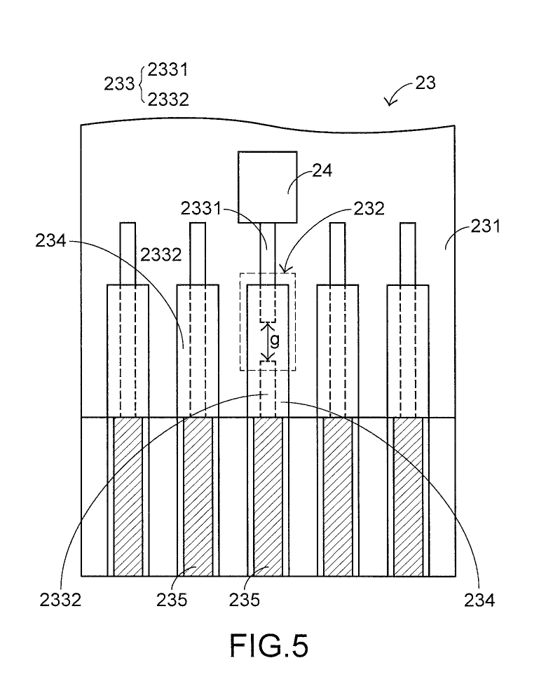

Next, a detailed structure of the membrane switch circuit 23 is described. Refer to FIG. 4 and FIG. 5 together. FIG. 5 is a schematic diagram of a partial structure of a membrane switch circuit of a keyboard according to a preferred embodiment of the present invention. The membrane switch circuit 23 includes a board body 231 and a plurality of circuit structures 232. The board body 231 consists of an upper circuit board (not shown in the figure), a spacer layer (not shown in the figure) and a lower circuit board (not shown in the figure). The architecture of the board body 231 is known by a person skilled in the art, and therefore is not described herein. The plurality of light emitting elements 24 is disposed on the board body 231 and electrically connected to the plurality of circuit structures 232, and can generate a plurality of light beams. The plurality of circuit structures 232 is disposed in the board body 231 (that is, between the upper circuit board and the lower circuit board) and connected to the light emitting element 24. Each circuit structure 232 includes a conductive circuit 233, a protection layer 234 and a contact portion 235. The conductive circuit 233 is disposed in the board body 231 and electrically connected to the light emitting element 24. The protection layer 234 wraps the conductive circuit 233 inside the board body 231, and is used for protecting the conductive circuit 233. The contact portion 235 is exposed out of the board body 231 and electrically connected to the conductive circuit 233, and can contact a power supply 26 to obtain power, so as to drive the membrane switch circuit 23 and the plurality of light emitting elements 24. The protection layer 234 partially wraps the contact portion 235, so as to protect the contact portion 235.

The conductive circuit 233 includes a first-section circuit 2331 and a second-section circuit 2332. A gap g is provided between the first-section circuit 2331 and the second-section circuit 2332. The first-section circuit 2331 and the second-section circuit 2332 are wrapped by the protection layer 234, so that a resistance value of the circuit structure 232 can be increased, thus reducing brightness of the light beam. Because the conductive circuit 233 is divided into the first-section circuit 2331 and the second-section circuit 2332 separate from each other, a series architecture of the first-section circuit 2331, the protection layer 234 located between the first-section circuit 2331 and the second-section circuit 2332, and the second-section circuit 2332 is formed. Therefore, the resistance value of the circuit structure 233 is a sum of a resistance value of the first-section circuit 2331, a resistance value of the second-section circuit 2332, and a resistance value of the protection layer 234 located in the gap g.

In this preferred embodiment, the first-section circuit 2331 and the second-section circuit 2332 are formed by printing a silver material inside the board body 231. The protection layer 234 is formed by printing a graphite material inside the board body 231, where the printed graphite material covers the first-section circuit 2331, the second-section circuit 2332 and the contact portion 235. The inside of the board body 231 refers to a lower surface of the upper circuit board or an upper surface of the lower circuit board.

It can be learned from the above description that, in the keyboard and membrane switch circuit according to the present invention, the conductive circuit in the board body is divided into the first-section circuit and the second-section circuit separate from each other, and the first-section circuit and second-section circuit are wrapped by the protection layer, thereby forming a series architecture of the first-section circuit, the protection layer located between the first-section circuit and the second-section circuit, and the second-section circuit is formed. Therefore, the resistance value of the circuit structure can be increased to a sum of the resistance value of the first-section circuit, the resistance value of the second-section circuit, and the resistance value of the protection layer located between the first-section circuit and the second-section circuit, so that the brightness of the light beam generated by the light emitting element can be reduced.

The foregoing descriptions are merely preferred embodiments of the present invention, but are not intended to limit the application scope of the present invention. Any other equivalent variation or modification made without departing from the spirit disclosed in the present invention shall fall within the application scope of the present invention.

What is claimed is:

1. A membrane switch circuit, connected to a light emitting element capable of generating a light beam, the membrane switch circuit comprising:
a board body; and
a circuit structure, disposed in the board body and connected to the light emitting element, the circuit structure comprising:
a conductive circuit, disposed in the board body and electrically connected to the light emitting element; and
a protection layer, wrapping the conductive circuit inside the board body and used for protecting the conductive circuit, wherein the conductive circuit comprises a first-section circuit and a second-section circuit, a gap is provided between the first-section circuit and the second-section circuit, and the first-section circuit and the second-section circuit are wrapped by the protection layer to increase a resistance value of the circuit structure, so as to reduce brightness of the light beam.

2. The membrane switch circuit according to claim 1, wherein the resistance value of the circuit structure is a sum of a resistance value of the first-section circuit, a resistance value of the second-section circuit, and a resistance value of the protection layer located between the first-section circuit and the second-section circuit.

3. The membrane switch circuit according to claim 1, wherein the circuit structure further comprises a contact portion, which is exposed out of the board body and electrically connected to the conductive circuit, so as to be in contact with a power supply to obtain power.

4. The membrane switch circuit according to claim 3, wherein the protection layer partially wraps the contact portion, so as to protect the contact portion.

5. The membrane switch circuit according to claim 1, wherein the first-section circuit and the second-section circuit are formed by printing a silver material inside the board body, and the protection layer is formed by printing a graphite material inside the board body.

6. A keyboard, comprising:
a light emitting element, disposed in the keyboard and used for generating a light beam;
a membrane switch circuit, disposed in the keyboard and electrically connected to the light emitting element, the membrane switch circuit comprising:
a board body; and
a circuit structure, disposed in the board body and connected to the light emitting element, the circuit structure comprising:
a conductive circuit, disposed in the board body and electrically connected to the light emitting element; and
a protection layer, covering the conductive circuit inside the board body and used for protecting the conductive circuit, wherein the conductive circuit comprises a first-section circuit and a second-section circuit, a gap is provided between the first-section circuit and the second-section circuit, and the first-section circuit and the second-section circuit are wrapped by the protection layer to increase a resistance value of the circuit structure, so as to reduce brightness of the light beam.

7. The membrane switch circuit according to claim 6, wherein the resistance value of the circuit structure is a sum of a resistance value of the first-section circuit, a resistance value of the second-section circuit, and a resistance value of the protection layer located between the first-section circuit and the second-section circuit.

8. The membrane switch circuit according to claim 6, wherein the circuit structure further comprises a contact portion, which is exposed out of the board body and electrically connected to the conductive circuit, so as to be in contact with a power supply to obtain power.

9. The membrane switch circuit according to claim 8, wherein the protection layer partially wraps the contact portion, so as to protect the contact portion.

10. The membrane switch circuit according to claim 6, wherein the first-section circuit and the second-section circuit are formed by printing a silver material inside the board body, and the protection layer is formed by printing a graphite material inside the board body.
